(19) United States
(12) Patent Application Publication
(10) Pub. No.: US 2007/0297458 A1
(43) Pub. Date: Dec. 27, 2007

(54) Efficient and layered synchronization protocol for database systems

(75) Inventors: Charumathy V. Narayanan, Hyderabad (IN); Sudarshan A. Chitre, Redmond, WA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 11/502,225

(22) Filed: Aug. 9, 2006

(30) Foreign Application Priority Data
Jun. 27, 2006 (IN) 1518/DEL/2006

(51) Int. Cl. H04J 3/06

(52) U.S. Cl. 370/503; 370/465

(57) ABSTRACT

An efficient and layered synchronization protocol for database systems is disclosed. A mechanism is provided for efficient synchronization of data between storage systems such as relational databases, object stores, etc. Synchronization capabilities may be defined and grouped into several levels that support specific scenarios. The levels may be defined in increasing order of capabilities. Such a synchronization protocol may be designed to work over communication protocols, such as HTTP, for example, between mobile devices and servers. The synchronization protocol may be an XML-based protocol that includes an envelope for handling extensibility and modularity and a body for representing data and metadata within the envelope.

### CROSS-REFERENCE TO RELATED APPLICATIONS

This application claims priority under 35 U.S.C. § 119(a) from Indian Patent Application No. 1518/DEL/2006, filed Jun. 27, 2006.

### BACKGROUND

Synchronization of data between two nodes (“a” and “b”) may require any number of capabilities depending on the synchronization requirements. For example, there may be a need to synchronize data only from a to b and not from b to a, there may be a need to synchronize some data but not all data, there may be a need to synchronize data from a to b and from b to a and also to detect conflicts (i.e., to determine whether one changed and the other did not).

Consider an example of two nodes synchronizing: a server node and a client node. The server may be updating data; the client may be browsing. A synchronization protocol may recognize this as an interesting pattern. Examples of synchronization scenarios include personal digital assistants, sales taking orders and synchronizing data on laptop inventory changes, prices, etc., and a number of clients sending orders to a data center where the orders get synchronized.

Such scenarios typically require a number of capabilities that synchronization supports. Typically, is a synchronization protocol is employed, all the capabilities are provided. There is no approach to pick and choose capabilities depending on the requirements of the system. There are approaches that enable a user to turn off capabilities that might not be desired, but they do not affect or simplify the underlying protocol.

Existing protocols also penalize the usage of replication, which tends to pay maximum cost. All data elements that need conflict detection, for example, pay maximum overhead. “Cost” may be, for example, what kind of metadata or amount of metadata the system needs to store over the user data (to be able to synchronize). Cost can be how much data gets communicated between nodes. A simple synchronization protocol requires less data to be communicated. Also, a simpler protocol has less computational overhead.

It would be desirable if, where certain complex features are not desired, the synchronization protocol simplified accordingly. It would be desirable to classify features into “buckets” of simplicity, i.e., to group meaningful items into levels, so that each level of protocol maps to valid user scenario. Classifying bucket of features that synchronization provides into subgroups or levels provides for user scenarios that allow for the development of a “pay as you go” protocol, where only the simplest protocol required for a particular scenario is employed.

### SUMMARY

A mechanism is provided for efficient synchronization of data between storage systems such as relational databases, object stores, etc. Synchronization capabilities or features may be classified or grouped into levels (e.g., L1, L2 L3, . . . ) that support specific scenarios. Examples of such scenarios include, for example, “offline browse scenario,” “offline update scenario,” etc. The levels may be defined in increasing order of capabilities.

A layered synchronization protocol may be defined that maps to each of the previously-defined levels. The synchronization protocol may be designed to work over communication protocols, such as HTTP, for example, between mobile devices and servers. The synchronization protocol may be an XML-based protocol that includes an envelope for handling extensibility and modularity and a body for representing data and metadata within the envelope.

### BRIEF DESCRIPTION OF THE DRAWINGS

FIG. 1 depicts an example scenario wherein it is possible for the Publisher, but not for the Subscriber, to change data.

FIG. 2 depicts an example scenario wherein changes are possible to data on both the Subscriber and the Publisher.

FIG. 3 depicts an example scenario wherein transactional data can be shared among several Subscribers.

FIG. 4 depicts an example scenario wherein the Publisher can change transactional data.

FIG. 5 depicts an example scenario wherein a Subscriber's changes can be uploaded to multiple Publishers.

FIG. 6 is a block diagram showing an example computing environment in which aspects of the invention may be implemented.

### DETAILED DESCRIPTION OF ILLUSTRATIVE EMBODIMENTS

As used herein, the term “replica” refers to an instance of data available on a specific machine. The term “publisher” refers to a replica that makes data available for replication to other replicas. The term “subscriber” refers to a replica that receives copies of published data. The term “publication” refers to a collection of one or more articles from one database. The term “article” refers to an object specified for replication. For example, in Microsoft Server, an article is a component in a publication and can be a table, specified columns, specified rows, a stored procedure or view definition, a view, an indexed view, or a user-defined function. The term “published data” refers to data at the publisher that has been replicated. The term “subscription” refers to a specific instance or copy of published data.

The “lineage” contains version information about the changed entity. In the synchronization protocol, this is treated as an opaque metadata BLOB (i.e., binary large object). Typically, the synchronization protocol implementation interprets and maintains the version metadata depicted by the lineage.

### Example Capability Definitions

A set of capabilities may be defined to provide whatever features are desired in a synchronization protocol. Such capabilities may then be grouped into different levels (L1, L2, etc) to provide a layered synchronization protocol. In an example embodiment, the following capabilities may be provided. It should be understood, however, that any capabilities may be defined, and that any number of capabilities may be defined.

The “Publisher updates on reference data” capability allows Publishers to make available reference data to Subscribers. Changes to the reference data are allowed only on the Publisher.

The “Filtered subsets of data” capability allows Publishers to make available different subsets of the same dataset to Subscribers.

The “Subscriber updates on transactional data specific to a subscription” capability allows specific Subscribers to update transactional data. This scenario is useful when the data being synchronized is well-partitioned and not shared by the clients that synchronize the data—for example, sales orders corresponding to a sales representative's customers.

The “Subscriber updates on transactional data shared by multiple subscriptions” capability allows multiple Subscribers to update transactional data. This scenario is useful when the data being synchronized is shared by the clients that synchronize the data—for example, sales orders corresponding to a sales team's customers. Conflicts are possible in this scenario.

The “Publisher and Subscriber updates on transactional data shared by multiple subscriptions” capability allows Publishers and multiple Subscribers to update transactional data. Conflicts are possible in this scenario and would need to be detected on both the Publisher and Subscriber.

The “Publisher Schema owner” capability describes the ability of the replica to own the schema of the dataset being replicated and also publish changes to the replicated schema. Typical deployment scenarios involve the Publisher owning this capability. It is not anticipated, however, that this capability will reside with the Subscriber replica when the Subscriber replica is the authoritative copy of the data.

The “conflict detection capability at Publisher” capability describes that if conflicts are possible, such conflicts are detected at the Publisher.

The “conflict detection capability at Subscriber” capability describes that if conflicts are possible, such conflicts are detected at the Subscriber.

The “conflict resolution capability at Publisher” capability describes that if conflicts are possible, such conflicts are resolved at the Publisher.

The “conflict resolution capability at Subscriber” capability describes that if conflicts are possible, such conflicts are resolved at the Subscriber.

The “Subscriber side change forwarding” capability allows the Subscriber to forward changes received from other replicas to the Publisher.

The “upload Subscriber's changes to a single Publisher” capability allows a change at the Subscriber to propagate to the first Publisher it synchronizes with, but not to Publishers contacted at subsequent merges. The limitation with this is that other Publishers only get this change via the Publisher that first synchronized with the Subscriber after the change was made.

The “upload Subscriber's changes to a multiple Publisher” capability allows a change at the Subscriber to propagate to multiple Publishers with which it synchronizes.

The “minimize redundant propagation of changes” allows the synchronization session to send only changes that are not already present on the destination. It is very possible in synchronization scenarios for a replica to already have seen a set of changes from a given partner. This could be due to out of band changes or if the Subscriber synchronizes with an alternate Publisher.

The “non-authoritative restore of publisher from subscriber” capability allows the scenario of restoring publisher to an older state and replicate data from subscriber to publisher to bring the publisher up-to-date with the subscriber.

The “non-authoritative restore of subscriber from publisher” capability allows the scenario of restoring subscriber to an older state and replicate data from publisher to subscriber to bring the subscriber up-to-date with the publisher.

The “preserve partition consistency for Publisher side updates” capability guarantees publisher side updates to be propagated to the Subscriber such that the subset of data at the Subscriber consistent with the Publisher.

The “accept out of partition updates on Subscriber” capability allows the Subscriber replica to upload changes to the Publisher that fall outside the partition to which the subscriber has subscribed.

The “preserve partition consistency for Subscriber side updates by sending compensating changes” capability prevents a Subscriber replica from uploading changes to the Publisher that fall outside the partition to which the subscriber has subscribed. Additionally, the Publisher propagates changes to the subscriber that revert such offending changes.

The following table groups these capabilities into five different sync protocol levels: L1-L5. It should be understood, however, that any number of capabilities may grouped into any number of protocol levels, and any protocol level may include any number of capabilities.

| | Capability | | | | |
|---|---|---|---|---|---|
| | L1 | L2 | L3 | L4 | L5 |
| Publisher updates on reference data | Yes | Yes | Yes | Yes | Yes |
| Filtered subsets for data | Yes | Yes | Yes | Yes | Yes |
| Subscriber updates on transactional data specific to | No | Yes | Yes | Yes | Yes |
| a subscription | | | | | |
| Subscriber updates on transactional data | No | No | Yes | Yes | Yes |
| shared by multiple subscriptions | | | | | |
| Publisher and Subscriber updates on | No | No | No | Yes | Yes |
| transactional data shared by multiple | | | | | |
| subscriptions. | | | | | |
| Publisher Schema Owner Capability | Yes | Yes | Yes | Yes | Yes |
| Conflict detection capability at Publisher | N/A | N/A | Yes | Yes | Yes |
| Conflict detection capability at Subscriber | N/A | N/A | Yes | Yes | Yes |
| Conflict resolution capability at Publisher | N/A | N/A | Yes | Yes | Yes |
| Conflict resolution capability at Subscriber | N/A | N/A | No | Yes | Yes |
| Subscriber side change forwarding capability | N/A | N/A | No | Yes | Yes |
| Upload Subscriber's changes to single | N/A | Yes | Yes | Yes | Yes |
| Publisher | | | | | |
| Upload Subscriber's changes to multiple | N/A | No | No | No | Yes |
| Publishers | | | | | |
| Minimize redundant propagation of changes | N/A | No | No | Yes | Yes |
| Non-authoritative restore of publisher from | N/A | No | No | Yes | Yes |
| subscriber | | | | | |
| Non-authoritative restore of subscriber from | Yes | Yes | Yes | Yes | Yes |
| publisher | | | | | |
| Preserve partition consistency for Publisher | Yes | Yes | Yes | Yes | Yes |
| side updates | | | | | |
| Accept out of partition updates on Subscriber | N/A | No | No | Yes | Yes |
| Preserve partition consistency for Subscriber | N/A | Yes | Yes | Yes | Yes |
| side updates by sending compensating | | | | | |
| changes | | | | | |

### Synchronization Protocol Message Formats

Message formats that may be used in a layered synchronization protocol will now be described. A “Message ID” may be defined as <Major Version Of Protocol>.<Minor Version of Protocol>.<Message Category>.<Message within category>. Which messages are valid for protocols at which levels will be described in detail below.

The originator of a “requestPublications” message [MessageID: 1.0.1.1] is the client. This message is sent by client to request the list of Publications that are available and the Subscriber has access to. An example “requestPublications” message follows:

```
<L1>
<requestPublications =”...”>
    <security>...</security>
    <filter>...</filter>
</requestPublications>
</L1>
```

The /requestPublications/security element specifies the security credentials of the Subscriber. It conforms to one of the Security Description Languages understood by the recipient. The recipient should send all the Publications that the Subscriber has access to in response to this message. The recipient may send Publications that the Subscriber does not have access to so that it may discover the presence of such publications, but it should not allow the Subscriber to subscribe to a publication that it does not have access to.

The /requestPublications/filter element specifies which publications the Subscriber wishes to enumerate. It conforms to one of the Filter Languages understood by the recipient. The recipient should send all the Publications that match this filter in response to this message. The recipient may send Publications that do not match the filter, but it should not.

The originator of a “conveyPublications” message [MessageID: 1.0.1.2] is the server. This message is sent as a response to a “conveyPublications” message sent by the Subscriber to request the list of Publications that are available and the Subscriber has access to. An example “conveyPublications” message follows:

```
<conveyPublications =”...”>
    <publication>...</publication >
        <id>...</id>
</conveyPublications>
```

The /conveyPublications/id element is a GUID identifying this request. Recipients MAY use this id to detect duplicate responses to the requestPublications message, but do NOT HAVE to do so. The /conveyPublications/publication element specifies the attributes of the publications that the Subscriber wishes to enumerate. The /conveyPublications/publication/id element uniquely (GUID) identifies this publication for the purposes of subscription. If a subscription request is sent via a requestSubscription message, it must specify the value of this attribute in the /requestSubscription/publication/id element.

The originator of the “requestSubscription” message [MessageID: 1.0.1.3] is the client. This message is sent by client to request a subscription to a given publication. An example “requestSubscription” message follows:

```
<requestSubscription =”...”>
    <id>...</id>
    <partition_identifier>...</ partition_identifier >
    <publication>...</publication >
        <id>...</id>
</requestSubscription>
```

The /requestSubscription/id element is a GUID identifying this request. Recipients MAY use this id to detect duplicate requestSubscription messages, but do NOT HAVE to do so. The /requestSubscription/publication/id element contains the id (copied from /conveyPublications/publication/id) of the publication the Subscriber wishes to subscribe to. The /requestSubscription/partition_identifier element contains a generic string the uniquely identifies the partition of data the Subscriber is interested in. This allows the Subscriber to request a subscription to a partition which is parameterized subset of data available at the Publisher. For example, the “SalesPersonData” publication might have made available different data sets unique to all the sales personnel in a company. The partition identifier allows the Subscriber to request a subscription to a specific data set—for example “sales person id=Mary Kate” could identify the identity of the salesperson.

The originator of a “grantSubscription” message [MessageID: 1.0.1.4] is the server. This message is sent by server to acknowledge the client's request for a subscription to a given publication. An example “grantSubscription” message follows:

```
<grantSubscription =”...”>
    <id>...</id>
    <subscription>...</ subscription >
        <id>...</id>
</ grantSubscription >
```

The /grantSubscription/id element is a GUID identifying this request. The /grantSubscription/subscription/id element contains the id (copied from /requestSubscription/id) of the subscription request the Publisher wishes to acknowledge.

The originator of a “removeSubscription” message [MessageID: 1.0.1.5] is the client. This message is sent by client to remove a subscription to a given publication. An example “removeSubscription” message follows:

```
<removeSubscription =”...”>
    <id>...</id>
    <partition_identifier>...</ partition_identifier >
    <publication>...</publication>
        <id>...</id>
</removeSubscription>
```

The /removeSubscription/id element is a GUID identifying this request. Recipients MAY use this id to detect duplicate removeSubscription messages, but do NOT HAVE to do so. The /removeSubscription/publication/id element contains the id (copied from /conveyPublications/publication/id) of the publication the Subscriber wishes to subscribe to. The /removeSubscription/partition_identifier element contains a generic string the uniquely identifies the partition of data the Subscriber is interested in. This allows the Subscriber to identify the subscription to a partition to which it has subscribed.

The originator of an “ackRemoveSubscription” message [MessageID: 1.0.1.6] is the server. This message is sent by server to acknowledge the client's request for removal of a subscription to a given publication. An example “ackRemoveSubscription” message follows:

```
<ackRemoveSubscription =”...”>
    <id>...</id>
    <subscription>...</ subscription >
        <id>...</id>
</ ackRemoveSubscription >
```

The /ackRemoveSubscription/id element is a GUID identifying this request. The /ackRemoveSubscription/subscription/id element contains the id (copied from /removeSubscription/id) of the subscription removal request the Publisher wishes to acknowledge.

The originator of a “requestPublicationSchema” message [MessageID: 1.0.2.1] is the client. This message is sent by client to request the schema corresponding to a given publication. An example “requestPublicationSchema” message follows:

```
<requestPublicationSchema =”...”>
    <id>...</id>
    <publication>...</publication>
        <id>...</id>
<requestPublicationSchema>
```

The /requestPublicationSchema/publication/id element contains the id (copied from /conveyPublications/publication/id) of the publication the Subscriber has subscribed to.

The originator of a “conveyPublicationSchema” message [MessageID: 1.0.2.2] is the server. This message is sent by server in response to the requestPublicationSchema message. An example “conveyPublicationSchema” message follows:

```
<conveyPublicationSchema =”...”>
    <publicationSchema>...</publicationSchema>
        <schemaVersion>...<schemaVersion>
</conveyPublicationSchema>
```

The /conveyPublicationSchema/publicationSchema element contains the publication schema defined as an XSD. The /conveyPublicationSchema/publicationSchema/schema Version element contains the version of the publication schema.

The originator of a “requestInitialData” message [MessageID: 1.0.2.3] is the client. This message is sent by client to request the initial data set corresponding to the subscription. An example “requestInitialData” message follows:

</requestInitialData =”...”>
</requestInitialData>

The originator of a “conveyInitialData” message [MessageID: 1.0.2.4] is the server. This message is sent by server in response to the requestInitialData message. An example “conveyInitialData” message follows:

<conveyInitialData =”...”>
</conveyInitialData>

The originator of a “requestDownloads” message [MessageID: 1.0.3.1] is the client. This message is sent by client to request incremental data to download. An example “requestDownloads” message follows:

<requestDownloads =”...”>
<lastDownloadSyncAnchor>...</lastDownloadSyncAnchor>
</requestDownloads>

The /requestDownloads/lastDownloadSyncAnchor element contains the sync anchor that the Subscriber received from the Publisher during the previous synchronization. This allows the Publisher to download only the changes that have occurred after the time the Subscriber last synchronized.

The originator of a “conveyDownloads” message [MessageID: 1.0.3.2] is the server. This message is sent as a response to a requestDownloads message sent by the Subscriber. An example “requestDownloads” message follows:

```
<conveyDownloads =”...”>
    <changes> ...</changes>
    <downloadSyncAnchor>...</downloadSyncAnchor>
</conveyDownloads>
```

The /conveyDownloads/changes element contains the incremental data changes in an XML form. The XML data adheres to the xsd schema for the publication sent in the conveyPublicationSchema message. The /conveyDownloads/downloadSyncAnchor element contains the sync anchor that the Subscriber MUST persist after having successfully processed all the downloads. This allows the Publisher to subsequently only send downloads for data that has changed since the previous synchronization session.

The originator of a “conveyuploads” message [MessageID: 1.0.3.3] is the subscriber. An example “conveyuploads” message follows:

```
<conveyUploads =”...”>
    <changes> ...</changes>
    <uploadSyncAnchor>...</uploadSyncAnchor>
</conveyUploads>
```

The /conveyUploads/changes element contains the incremental data changes in an XML form. The XML data adheres to the xsd schema for the publication sent in the conveyPublicationSchema message. The /conveyUploads/uploadSyncAnchor element contains the sync anchor that the Publisher returns in the ackUploads message after it has successfully consumed all the uploaded data. This allows the Subscriber to subsequently only send uploads for data that has changed since the previous synchronization session.

The originator of an “ackUploads” message [MessageID: 1.0.3.3] is the publisher. An example “ackUploads” message follows:

<ackUploads =”...”>
<uploadSyncAnchor>...</uploadSyncAnchor>
</ackUploads>

The /ackUploads/uploadSyncAnchor element contains the sync anchor that the Publisher returns to the Subscriber. This allows the Subscriber to subsequently only send uploads for data that has changed since the previous synchronization session.

The originator of a “publisherErrors” message [MessageID: 1.0.4.1] is the publisher. This message is sent by publisher in response to any of the client requests to indicate error states. An example “publisherErrors” message follows:

```
<publisherErrors>
    <publisherError>
        <error_id>...</error_id>
        <errorSource>...</errorSource>
        <errorDescription>...</errorDescription>
    </publisherError> />
</publisherErrors>
```

The /publisherError/error_id element identifies the error. The /publisherError/errorSource element identifies the source of the error. The /publisherError/errorDescription element identifies the error using a string representation.

### Example Protocol Level Definitions

In an example embodiment, the Publisher can understand multiple levels at one time. The Subscriber would select a level from among the several levels offered, and operate at that level. Thus, the Subscriber could select the lowest (i.e., simplest) level at which it can operate and still provide all the features that it would need to perform in a particular scenario.

Protocol layering provides for classifying capabilities in such a way that capabilities that are unnecessary for a certain scenario, where data handling might not be as complex, are not necessarily provided. The capabilities can be grouped based on typical, real-world scenarios. The capabilities in a certain group map to one or more real-world scenarios. Thus, only the lowest required protocol level needs to be provided. Higher-level protocols are accumulative and can service lower-level applications. For example, if a node supports level 3, then it also supports level 2 and level 1. The server should be configured (or implemented) to handle up to the maximum level. If the client comes in with a request that is not supported by the highest-level protocol the server can support, then the server will simply not respond. For example, if the client supports level 3, and the server supports only level 2, then the server may be unable to support the client's request.

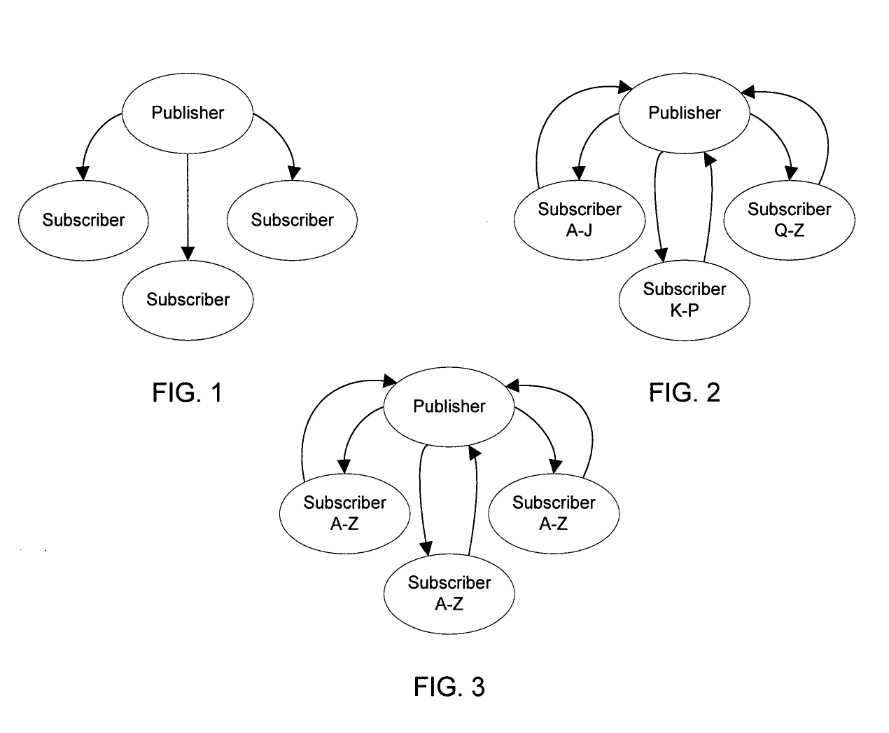

A first subset of the set of defined capabilities may be grouped into a first-level protocol, L1. L1 may be applicable to a scenario as depicted in FIG. 1, wherein it is possible for the server, but not for the client, to change the data. An example of such a scenario may be where the server provides reference data that the client may reference, e.g., data, such as a product catalog, for example, that the client may want to have available (on the client) even when the client is not connected to the server. The client is not permitted to change the data on the server. Each client can get all data or its own subset of data. L1 may include a discovery protocol, an initial data population protocol, and an incremental synchronization protocol.

The discovery protocol defines the set of messages that are needed to establish a synchronization relationship between a client (Subscriber) and a server (Publisher). Suppose, for example, that a Publisher makes data available. A Subscriber “discovers” from the Publisher what data is available. The Subscriber may be interested in a certain subset (partition) of the available data, and asks for that subset.

The first phase of this protocol is optional since it allows any L1 client to talk to any L1 server and discover the set of publications that are available and accessible. The request subscription phase of the protocol is mandatory in order to establish the synchronization relationship between the Publisher and Subscriber replicas. The following table provides a list of messages that may be included in the discovery protocol.

| Message ID | Message | Message contents | Originator | Related Message |
|---|---|---|---|---|
| 1.0.1.1 | requestPublications | Security | Subscriber | 1.0.1.2 |
| | | Information | | |
| 1.0.1.2 | conveyPublications | Collection of | Publisher | 1.0.1.1 |
| | | publications that | | |
| | | the client has | | |
| | | access to | | |
| | | subscriber to. | | |
| 1.0.1.3 | request Subscription | Name of the | Subscriber | 1.0.1.4 |
| | | publication + | | |
| | | parameters for | | |
| | | identifying the | | |
| | | subset of data to | | |
| | | subscribe to. | | |
| 1.0.1.4 | grantSubscription | Acknowledgement | Publisher | 1.0.1.3 |
| | | of successful | | |
| | | subscription | | |
| 1.0.1.5 | remove Subscription | Name of the | Subscriber | 1.0.1.6 |
| | | publication + | | |
| | | parameters for | | |
| | | identifying the | | |
| | | subset of data to | | |
| | | subscribe to. | | |
| 1.0.1.6 | ackRemoveSubscription | Acknowledgement | Publisher | 1.0.1.5 |
| | | of successful | | |
| | | removal of | | |
| | | subscription | | |
| 1.0.4.1 | publisherErrors | Error context | Publisher | 1.0.1.* |
| | | information | | |

The initial data population protocol defines the set of messages that are needed to populate the data set of the Subscriber replica that has already successfully established a subscription to a given Publication. The following table provides a list of messages that may be included in the initial data population protocol.

| Message ID | Message | Message Contents | Originator | Related ID |
|---|---|---|---|---|
| 1.0.2.1 | requestPublicationSchema | Name and | Subscriber | 1.0.2.2 |
| | | identifier of the | | |
| | | publication. | | |
| 1.0.2.2 | conveyPublicationSchema | Schema for the | Publisher | 1.0.2.1 |
| | | publication as an xsd. | | |
| 1.0.2.3 | requestInitialData | Request data to | Subscriber | 1.0.2.4 |
| | | populate | | |
| | | Subscriber | | |
| | | database with | | |
| | | all the data that | | |
| | | belongs to the | | |
| | | subscribed | | |
| | | partition. | | |
| 1.0.2.4 | conveyInitialData | Initial data in an | Publisher | 1.0.2.3 |
| | | xml form. The | | |
| | | xml data | | |
| | | adheres to the | | |
| | | XSD schema | | |
| | | for the publication | | |
| | | sent in message | | |
| | | 1.3.2.2 | | |
| 1.0.4.1 | publisherErrors | Error context | Publisher | 1.0.2.* |
| | | information | | |

The following table provides a list of messages that may be included in the initial data population protocol.

| Message ID | Message | Message Contents | Originator | Related ID |
|---|---|---|---|---|
| 1.0.3.1 | requestDownloads | Last Download Sync | Subscriber | 1.0.3.2 |
| | | Anchor based on the data | | |
| | | the client already has | | |
| | | downloaded from the | | |
| | | Publisher | | |
| 1.0.3.2 | conveyDownloads | Incremental data in an | Publisher | 1.0.3.1 |
| | | xml form. The xml data | | |
| | | adheres to the xsd schema | | |
| | | for the publication sent in | | |
| | | the | | |
| | | conveyPublicationSchema | | |
| | | message + | | |
| | | New anchor value to store | | |
| | | on the client for next | | |
| | | sync. | | |
| | | This will be specified as | | |
| | | the last download sync | | |
| | | anchor that the Subscriber | | |
| | | received from the | | |
| | | Publisher during the next | | |
| | | synchronization. | | |
| 1.0.4.1 | publisherErrors | Error context information | Publisher | 1.0.3.* |

A second subset of the set of defined capabilities may be grouped into a second-level protocol, L2. L2 may be applicable to a scenario as depicted in FIG. 2, wherein changes are possible to data on both the client and the server. Transactional data is an example of data that may be changed on both the client and the server. Each client would have its own subset of data, so there would be no conflicts between clients. Also, the server and client would not be changing same data. The server would not be updating transactional data. The server could update reference data, but client would not.

L2 may include a discovery protocol, an initial data population protocol, and an incremental synchronization protocol. L2 may have capabilities that are cumulative over L1 capabilities. Additionally, L2 protocol allows subscribers to make updates to the data.

The discovery and initial data population protocol messages for L2 are the same as for L1. L2, however, allows subscribers to make updates to the data. The incremental synchronization part of the protocol has an additional phase to send changes from subscriber to the publisher, as described in the following table.

| Mes- | | | | |
|---|---|---|---|---|
| sage | | | Origi- | Related |
| ID | Message | Message Contents | nator | ID |
| 1.0.3.3 | conveyUploads | Incremental data in an | Sub- | 1.0.3.4 |
| | | xml form. The xml data | scriber | |
| | | adheres to the xsd schema | | |
| | | for the publication sent in | | |
| | | the | | |
| | | conveyPublicationSchema | | |
| | | message. | | |
| 1.0.3.4 | ackUploads | Anchor for the data | Pub- | 1.0.3.3 |
| | | accepted by the publisher. | lisher | |

A third subset of the set of defined capabilities may be grouped into a third-level protocol, L3. L3 may be applicable to a scenario as depicted in FIG. 3, wherein transactional data can be shared among several clients. An example of such a scenario may be a sales team, where more than one subscriber is servicing the same customer. There could be conflicts between clients, but not between the server and a client. The server checks for and resolves such conflicts.

L3 may include discovery and initial data population protocols that are the same as L2. L3 may have capabilities that are cumulative over L2 capabilities. Additionally, L3 protocol allows multiple subscribers to make updates to the same set of data. It detects and resolves conflicts at the publisher side. To handle conflicts due to simultaneous updates to the same data by multiple subscribers, the L3 exchanges lineage information for each changed entity in its incremental synchronization phase, which is described in the following table.

| Message ID | Message | Message Contents | Originator | Related ID |
|---|---|---|---|---|
| 1.0.3.2 | conveyDownloads | Incremental data in an | Publisher | 1.0.3.1 |
| | | xml form. The xml data | | |
| | | adheres to the xsd schema | | |
| | | for the publication sent in | | |
| | | the | | |
| | | conveyPublicationSchema | | |
| | | message + | | |
| | | New anchor value to store | | |
| | | on the client for next | | |
| | | sync. + | | |
| | | Lineage information for | | |
| | | each changed entity. | | |
| 1.0.3.3 | conveyUploads | Incremental data in an | Subscriber | 1.0.3.4 |
| | | xml form. The xml data | | |
| | | adheres to the xsd schema | | |
| | | for the publication sent in | | |
| | | the | | |
| | | conveyPublicationSchema | | |
| | | message + | | |
| | | Lineage information for | | |
| | | each changed entity. | | |
| 1.0.3.4 | ackUploads | Anchor for the data | Publisher | 1.0.3.3 |
| | | accepted by the publisher. | | |
| | | + updated lineage | | |
| | | information for the | | |
| | | uploaded rows. | | |

Similarly, a fourth subset of the set of defined capabilities may be grouped into a fourth-level protocol, L4, a fifth subset of the set of defined capabilities may be grouped into a fifth-level protocol, L5, and so on.

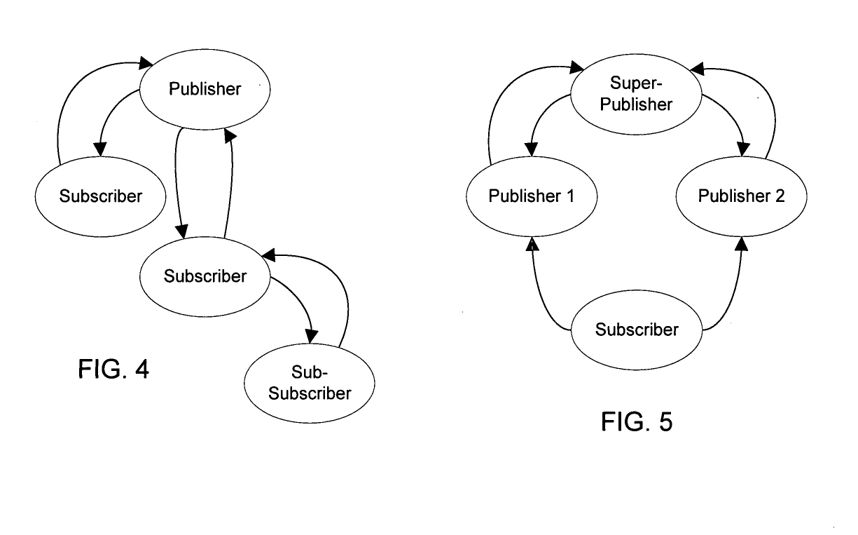

L4 may have capabilities that are cumulative over L3, and may be applicable to a scenario as depicted in FIG. 4, wherein the Publisher can change transactional data. There is therefore a need to detect and resolve conflicts between the several subscribers and the publisher. Also, L4 includes the capability for each subscriber to forward changes to other subscribers. Thus, each subscriber may act like a publisher with respect to its sub-subscribers.

L5 may have capabilities that are cumulative over L4, and may be applicable to a scenario as depicted in FIG. 5, wherein a Subscriber's changes can be uploaded to multiple publishers. An example of such a scenario may be for load-balancing, where each client can up load to more than one publisher. The client sends the same data to more than one publisher. This may be referred to as “replicating.” There is a need in this scenario to resolve conflicts between publishers.

### Example Computing Environment

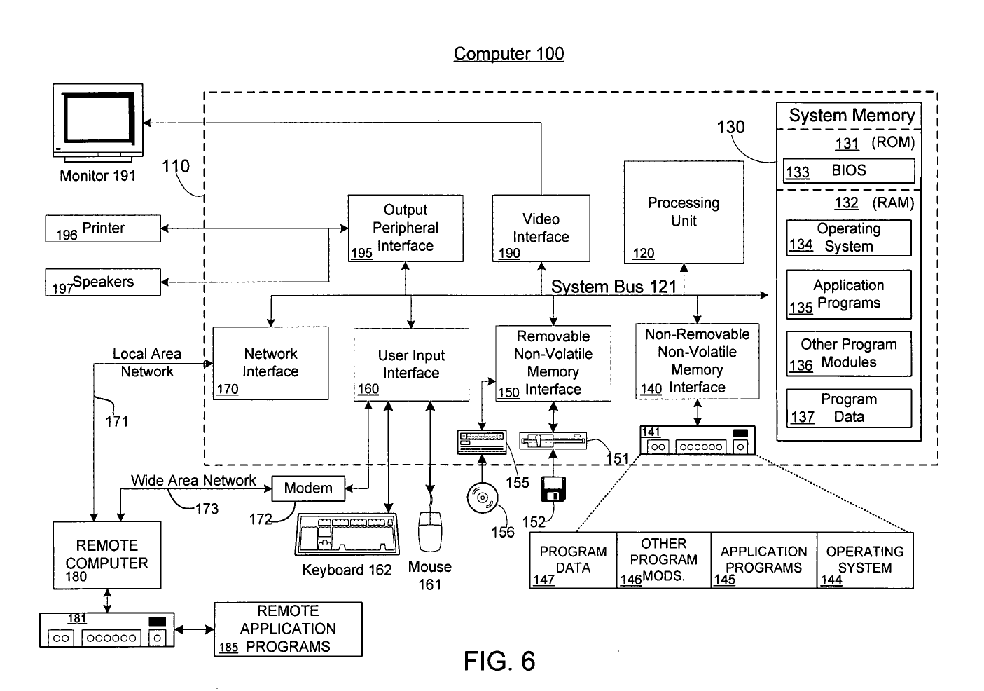

FIG. 6 and the following discussion are intended to provide a brief general description of a suitable computing environment in which an example embodiment of the invention may be implemented. It should be understood, however, that handheld, portable, and other computing devices of all kinds are contemplated for use in connection with the present invention. While a general purpose computer is described below, this is but one example. The present invention also may be operable on a thin client having network server interoperability and interaction. Thus, an example embodiment of the invention may be implemented in an environment of networked hosted services in which very little or minimal client resources are implicated, e.g., a networked environment in which the client device serves merely as a browser or interface to the World Wide Web.

Although not required, the invention can be implemented via an application programming interface (API), for use by a developer or tester, and/or included within the network browsing software which will be described in the general context of computer-executable instructions, such as program modules, being executed by one or more computers (e.g., client workstations, servers, or other devices). Generally, program modules include routines, programs, objects, components, data structures and the like that perform particular tasks or implement particular abstract data types. Typically, the functionality of the program modules may be combined or distributed as desired in various embodiments. Moreover, those skilled in the art will appreciate that the invention may be practiced with other computer system configurations. Other well known computing systems, environments, and/or configurations that may be suitable for use with the invention include, but are not limited to, personal computers (PCs), automated teller machines, server computers, hand-held or laptop devices, multi-processor systems, microprocessor-based systems, programmable consumer electronics, network PCs, minicomputers, mainframe computers, and the like. An embodiment of the invention may also be practiced in distributed computing environments where tasks are performed by remote processing devices that are linked through a communications network or other data transmission medium. In a distributed computing environment, program modules may be located in both local and remote computer storage media including memory storage devices.

FIG. 6 thus illustrates an example of a suitable computing system environment 100 in which the invention may be implemented, although as made clear above, the computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

With reference to FIG. 6, an example system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 110 typically includes a variety of computer readable media. Computer readable media can be any available media that can be accessed by computer 110 and includes both volatile and nonvolatile, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, random access memory (RAM), read-only memory (ROM), Electrically-Erasable Programmable Read-Only Memory (EEPROM), flash memory or other memory technology, compact disc read-only memory (CDROM), digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared, and other wireless media. Combinations of any of the above should also be included within the scope of computer readable media.

The system memory 130 includes computer storage media in the form of volatile and/or nonvolatile memory such as ROM 131 and RAM 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 6 illustrates operating system 134, application programs 135, other program modules 136, and program data 137. RAM 132 may contain other data and/or program modules.

The computer 110 may also include other removable/non-removable, volatile/nonvolatile computer storage media. By way of example only, FIG. 6 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD ROM or other optical media. Other removable/non-removable, volatile/nonvolatile computer storage media that can be used in the example operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 6 provide storage of computer readable instructions, data structures, program modules and other data for the computer 110. In FIG. 6, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120a-f through a user input interface 160 that is coupled to the system bus 121, but may be connected by other interface and bus structures, such as a parallel port, game port or a universal serial bus (USB).

A monitor 191 or other type of display device is also connected to the system bus 121 via an interface, such as a video interface 190. In addition to monitor 191, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 6. The logical connections depicted in FIG. 6 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 6 illustrates remote application programs 185 as residing on memory device 181. It will be appreciated that the network connections shown are exemplary and other means of establishing a communications link between the computers may be used.

One of ordinary skill in the art can appreciate that a computer 110 or other client devices can be deployed as part of a computer network. In this regard, the present invention pertains to any computer system having any number of memory or storage units, and any number of applications and processes occurring across any number of storage units or volumes. An embodiment of the present invention may apply to an environment with server computers and client computers deployed in a network environment, having remote or local storage. The present invention may also apply to a standalone computing device, having programming language functionality, interpretation and execution capabilities.

What is claimed:

1. A method for providing a synchronization protocol, the method comprising:
defining a set of synchronization capabilities;
grouping the synchronization capabilities into a plurality of subsets;
enabling a network node to select from among the plurality of subsets; and
configuring the network node with the capabilities grouped into the selected subsets.

2. The method of claim 1, wherein each of the subsets corresponds to a synchronization scenario.

3. The method of claim 2, wherein a first of the subsets provides synchronization capabilities for a scenario wherein it is possible for a publisher, but not for a subscriber, to change data.

4. The method of claim 3, wherein a second of the subsets provides synchronization capabilities for a scenario wherein changes are possible to data on both the subscriber and the publisher.

5. The method of claim 4, wherein a third of the subsets provides synchronization capabilities for a scenario wherein transactional data can be shared among several subscribers.

6. The method of claim 5, wherein a fourth of the subsets provides synchronization capabilities for a scenario wherein the publisher can change transactional data.

7. The method of claim 6, wherein a fifth of the subsets provides synchronization capabilities for a scenario wherein a subscriber's changes can be uploaded to multiple publishers.

8. A network node, comprising:
means for configuring the network node to select from among a plurality of synchronization protocol layers, wherein each layer corresponds to a respective set of one or more synchronization capabilities; and
means for providing the synchronization capabilities that correspond to the selected protocol layer.

9. The network node of claim 8, wherein the plurality of protocol layers includes a higher-level protocol layer and a lower-level protocol layer, the higher level protocol layer provide at least one capability that the lower-level protocol layer does not provide.

10. The network node of claim 9, wherein the higher-level protocol layer provides all the capabilities that the lower-level protocol layer provides.

11. The network node of claim 9, wherein each of the higher- and lower-level protocol layers provides for storing metadata, and wherein higher-level protocol layer provides for storing more complex metadata than does the lower-level protocol layer.

12. The network node of claim 9, wherein each of the higher- and lower-level protocol layers provides algorithms that work on metadata, and wherein higher-level protocol layer provides for more complex algorithms than does the lower-level protocol layer.

13. The network node of claim 9, wherein lower-level protocol layer provides for less CPU usage than does the higher-level protocol layer.

14. The network node of claim 9, wherein lower-level protocol layer provides for less network usage than does the higher-level protocol layer.

15. The network node of claim 9, wherein the network node is a publisher that is configured to operate at a higher protocol level than is a subscriber with which the publisher communicates.

16. The network node of claim 9, wherein the network node is a subscriber that is configured to operate at a lower protocol level than is a publisher with which the subscriber communicates.

17. A layered synchronization protocol, comprising:
a plurality of protocol phases, wherein each phase is defined by one or more synchronization capabilities.

18. The network node of claim 17, wherein a first of the phases is a discovery phase wherein a set of messages are defined for establishing a synchronization relationship between a subscriber and a publisher.

19. The network node of claim 17, wherein a second of the phases is an initial data population phase wherein a set of messages is defined for populating a data set of a subscriber replica that has successfully established a subscription to a given publication.

20. The network node of claim 17, wherein a third of the phases is an incremental synchronization phase wherein a set of messages is defined for synchronizing data between a subscriber and a publisher.
